(19) United States
(12) Patent Application Publication
(10) Pub. No.: US 2014/0159852 A1
(43) Pub. Date: Jun. 12, 2014

(54) TRANSFORMER

(71) Applicants: Hiroki Miura, Tokyo (JP); Hironobu Takahashi, Nagaokakyo-shi (JP); Keiichi Ichikawa, Nagaokakyo-shi (JP)

(72) Inventors: Hiroki Miura, Tokyo (JP); Hironobu Takahashi, Nagaokakyo-shi (JP); Keiichi Ichikawa, Nagaokakyo-shi (JP)

(73) Assignees: MURATA MANUFACTURING CO., LTD., Nagaokakyo-shi, Kyoto (JP); SUMIDA CORPORATION, Tokyo (JP)

(21) Appl. No.: 14/236,526

(22) PCT Filed: Apr. 25, 2012
(86) PCT No.: PCT/JP2012/061050

§ 371 Date: Jan. 31, 2014

(30) Foreign Application Priority Data
Aug. 24, 2011 (JP) 2011-183049

(51) Int. Cl. H01F 27/02

(52) U.S. Cl. CPC H01F 27/02
USPC 336/208

(57) ABSTRACT

To greatly improve the productivity, the general versatility, the downsizing, the performance and the like, as compared to those of the conventional transformer, provided is a transformer including: a core; a primary winding; a secondary winding; a bobbin provided with a low voltage side coil winding portion and a high voltage side coil winding portion, wherein the secondary winding is wound onto each of the coil winding portions; and a casing disposed so as to cover an outer periphery of the bobbin, wherein the primary winding is wound onto a portion of an outer periphery of the casing corresponding to a position of the low voltage side coil winding portion.

### TECHNICAL FIELD

The present invention relates to a transformer for use in, for example, a circuit for lighting a vehicle headlamp using a metal halide lamp or a circuit for converting a high voltage to a low voltage.

### BACKGROUND ART

Conventionally, when a high voltage discharge lamp (for example, metal halide lamp) which needs a high voltage at startup is used as a vehicle headlamp, a high voltage transformer which outputs a high voltage have been used, as disclosed in Japanese Laid-open Patent Application Publication No. 8-130127 (Patent Literature 1), for example.

The conventional high voltage transformer, as disclosed in Japanese Laid-open Patent Application Publication No. 8-130127 (Patent Literature 1), is constituted by a core, a hollow cylindrical shaped spool into the hollow portion of which the core is inserted, a secondary winding wound around the outer periphery of the spool, a casing made of a resin covering the spool being wound with the secondary winding, and a primary winding being inserted into the casing. The core, the spool and the secondary winding are housed in the casing, covered with a filled resin, and are fixed and integrated. Further, it is disclosed in Japanese Laid-open Patent Application Publication No. 8-130127 (Patent Literature 1) that by inserting the both ends of the primary winding being disposed on the casing of a printed circuit board, the core, the spool, the secondary winding, the casing and the printed circuit board are integrated, and the high voltage transformer is configured.

### CITATION LIST

### Patent Literature

Patent Literature 1: Japanese Laid-open Patent Application Publication No. 8-130127

### SUMMARY OF INVENTION

### Technical Problem

As described above, with regard to the structure in which the casing is inserted to the printed circuit board and secured integrally by filling the resin material into the space between the outer periphery of the spool and the inner surface of the casing, like the transformer as known in Japanese Laid-open Patent Application Publication No. 8-130127 (Patent Literature 1), the positions of the through-holes are different depending on the arrangement of the circuit and the like of the printed circuit board, and so there is a problem that general versatility is lacked.

In addition, because a work of filling the resin material into the space between the outer periphery of the spool and the inner surface of the casing is required, the assembling work grows complicated, the working man-hours increase, and further, some waiting time for curing of the filled resin material is needed. Therefore, there is a problem that productivity grows poor as a whole and cost increase is induced.

Thus, the present invention has been made in view of the above described problems, and the object of the present invention is to provide a transformer that can greatly improve the productivity, the general versatility, the downsizing, the performance and the like, as compared to those of the conventional transformer.

### Solution to Problem

In order to achieve the above described object, a transformer according to the present invention comprises: a core; a primary winding; a secondary winding; a bobbin provided with a low voltage side coil winding portion and a high voltage side coil winding portion, wherein the secondary winding is wound onto each of the coil winding portions; and a casing disposed so as to cover an outer periphery of the bobbin, wherein the primary winding is wound onto a portion of an outer periphery of the casing corresponding to a position of the low voltage side coil winding portion.

According to the configuration, the transformer can be formed by covering the outer periphery of the bobbin onto which the secondary winding is wound, with the casing, and winding the primary winding onto the portion of the outer periphery of the casing corresponding to the position of the low voltage side coil winding portion. In this way, by winding the primary winding to the portion overlapping with the low voltage side winding of the secondary winding, the parasitic capacitance generated in the high voltage side winding of the secondary winding by the primary winding can be reduced. Accordingly, the electric power loss at high frequencies can be reduced. Further, because the energy stored in the parasitic capacitance increases with increasing potential between the primary winding and the secondary winding, it is possible to reduce the energy stored in the parasitic capacitance, and thereby reduce the electric power loss due to leakage current at high frequencies, by winding the primary winding over the outer periphery of the low voltage side coil winding of the secondary winding. In addition, insulation properties between the primary winding and the secondary winding can be assured.

In the above described configuration, a configuration can be employed where the secondary winding is a high voltage winding and the primary winding is a low voltage winding, and the primary winding is placed and wound in a portion corresponding to an area between the both ends of the low voltage side coil winding portion.

According to the configuration, by placing the primary winding in the portion corresponding to the region between the both ends of the low voltage coil winding portion and winding the primary winding therein, the distance between the high voltage side coil winding of the secondary winding and the low voltage side coil winding of the secondary winding, and the distance between the low voltage side coil winding of the secondary winding and the primary winding can be gotten closer. Accordingly, the coupling coefficient grows larger and so a high coupling is obtained. In addition, the length of the transformer in the longitudinal direction can be shortened by winding the primary winding onto the outer periphery of the casing.

In the above described configuration, a configuration can be employed where the casing is formed in a hollow box-shaped body provided with an opening on a lower surface of the outer periphery thereof for receiving and accommodating the bobbin therein, and the opening has a retaining protrusion to engage the accommodated bobbin.

According to the configuration, by covering the bobbin with the casing from the upper side of the bobbin and accommodating the bobbin to a predetermined position in the case from the opening of the outer periphery lower surface of the casing, the bobbin is covered with the casing and the retaining protrusion engages the bobbin, and then the bobbin and the casing are fixed together. Thereby, the work of filling an insulation resin or the like between the casing and the bobbin and of fixing the bobbin and the casing becomes unnecessary. In addition, in a case the bobbin is accommodated in the casing from the terminal block portion side in the longitudinal direction of the bobbin, it is necessary to provide an opening having a size capable of passing the terminal block portion attached to the bobbin, and so the overall size of the casing grows larger. However, as disclosed in this configuration, in the case the opening is provided to the lower surface of the casing and the bobbin is covered with the casing from the upper side of the bobbin, it is enough to provide an opening having at least a size of the outer diameter of the bobbin and so the size of the bobbin can be reduced.

In the above described configuration, a configuration can be employed where the casing is provided with an insulation tape onto the outer periphery thereof where the primary winding is wound.

According to the configuration, insulation properties between the primary winding wound onto the outer periphery of the casing and the secondary winding wound onto the outer periphery of the bobbin can be assured by the insulation tape.

In the above described configuration, a configuration can be employed where the core comprises an I type magnetic body core and a C type magnetic body core.

According to the configuration, the I type magnetic material core and the C type magnetic material core form a closed magnetic circuit and so the magnetic flux leakage can be reduced.

### Advantageous Effects of Invention

According to the present invention, the bobbin and the casing are integrated by covering the outer periphery of the bobbin onto which the secondary winding is wound, with the casing, and winding the primary winding onto the portion of the outer periphery of the casing corresponding to the position of the low voltage side coil winding portion. As a result, for assuring the insulation properties between the secondary winding and the primary winding, the resin material which has been filled into the space between the secondary winding and the primary winding conventionally can be omitted and the work can be simplified, and so it becomes possible to promote reduction of man-hours of the work and to expect increase of productivity. In addition, because the coupling coefficient between the secondary winding and the primary winding grows larger and so a high coupling can be obtained, by getting closer the distance between the secondary winding and the primary winding, the higher performance can be expected.

Further, in the present invention, the casing and the bobbin are configured to be fixed and secured, by attaching the casing so as to cover the bobbin. This is different from the conventional transformer in which the casing and the bobbin are integrated by using through-holes and the like of the printed circuit board side. As a result, a product having general versatility is obtained without depending on the shape of the printed circuit board and the like. Accordingly, further improvement of productivity, simplification of the shape, downsizing and the like can be expected.

### BRIEF DESCRIPTION OF DRAWINGS

FIG. 1 is an external perspective view of a transformer according to one embodiment of the present invention, viewed from the front side obliquely upward direction.

FIG. 2 is an external perspective view of the transformer according to one embodiment of the present invention, viewed from the rear side obliquely upward direction.

FIG. 3 is an enlarged plan view of the transformer according to one embodiment of the present invention, viewed from the lower side direction.

FIG. 4 is a line A-A schematic longitudinal sectional view of FIG. 2.

FIG. 5 is a line B-B schematic longitudinal sectional view of FIG. 4.

FIG. 6 is an exploded perspective view for explaining a state before attaching a casing to a bobbin of the transformer according to one embodiment of the present invention.

FIG. 7 is an explanatory view for explaining a state in which the casing is attached to the bobbin of the transformer according to one embodiment of the present invention.

FIG. 8 is a schematic longitudinal sectional view showing a transformer according to another embodiment of the present invention.

FIG. 9 is a line C-C schematic longitudinal sectional view of FIG. 8.

### DESCRIPTION OF EMBODIMENTS

Hereinafter, embodiments for carrying out the present invention (hereinafter referred to as “embodiment”) shall be described in detail with reference to the accompanying drawings.

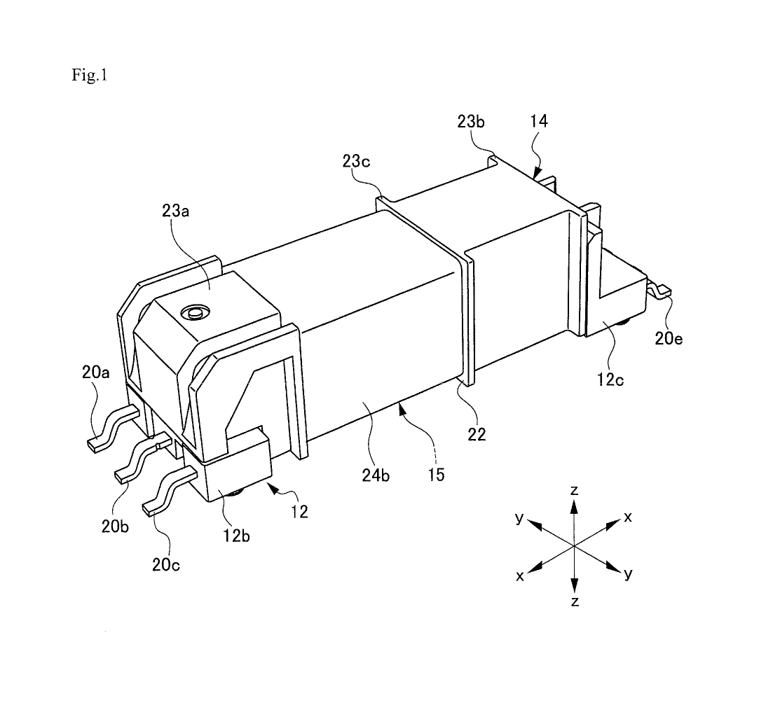

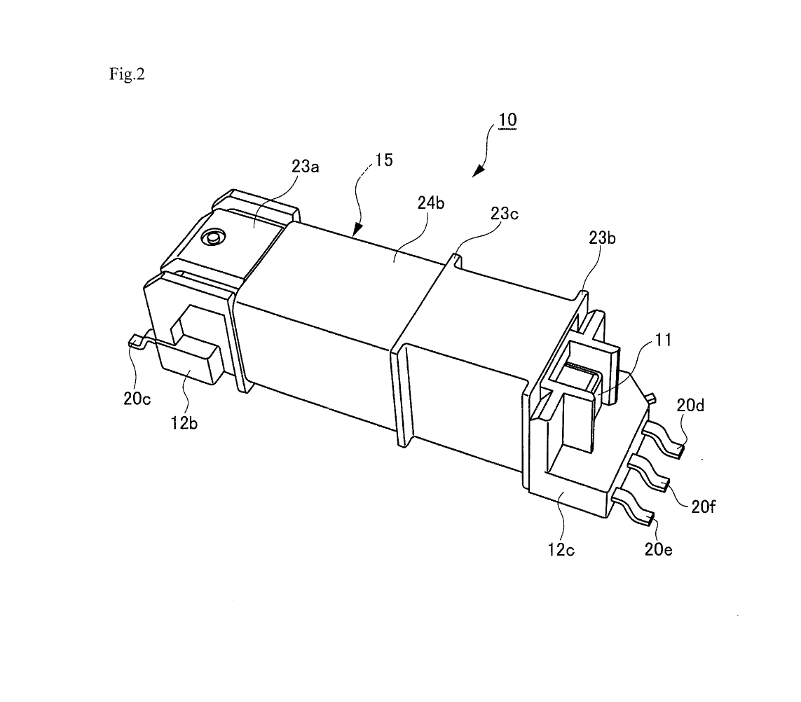

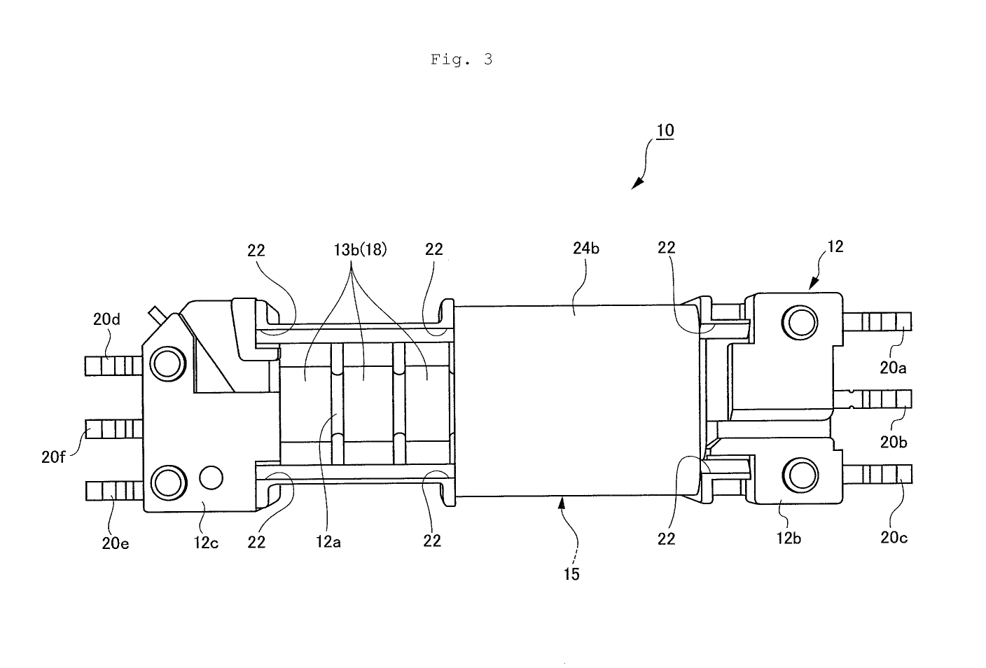

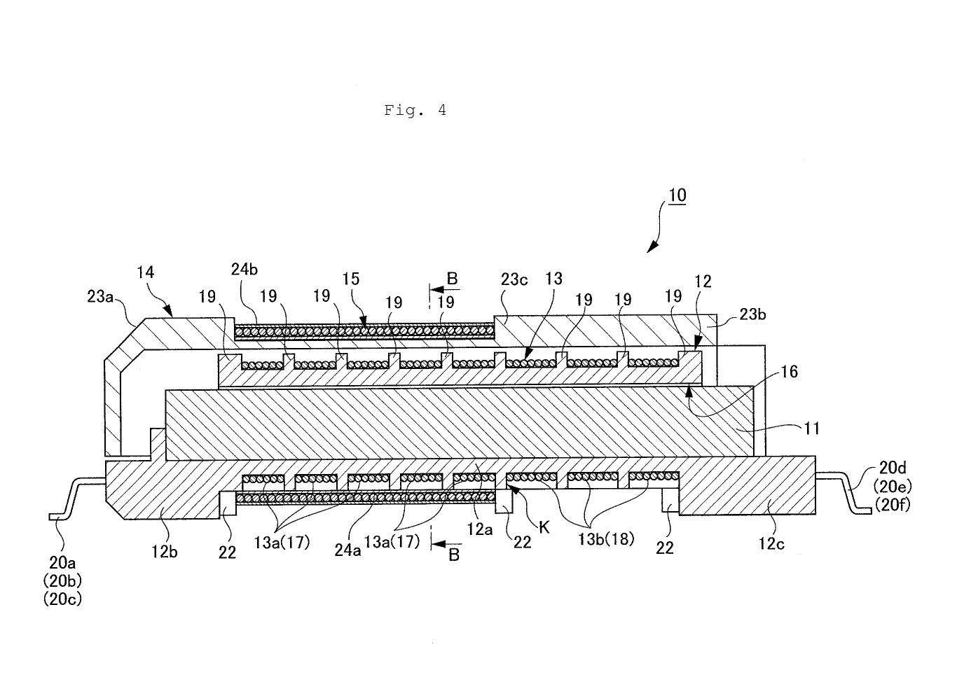

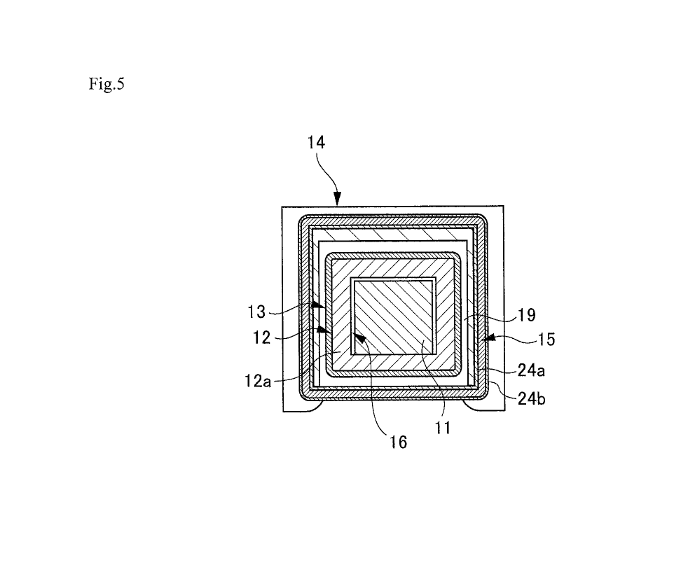

FIG. 1 and FIG. 2 illustrate a transformer according to one embodiment of the present invention. FIG. 1 is an external perspective view of the transformer, viewed from the front side obliquely upward direction. FIG. 2 is an external perspective view of the transformer, viewed from the rear side obliquely upward direction. FIG. 3 is an enlarged plan view of the transformer, viewed from the lower direction. FIG. 4 is a line A-A schematic longitudinal sectional view of FIG. 2. FIG. 5 is a line B-B schematic longitudinal sectional view of FIG. 4. In addition, The X-X direction of FIG. 1 is described as longitudinal direction, the Y-Y direction of FIG. 1 is described as horizontal direction and the Z-Z direction of FIG. 1 is described as vertical direction,

A transformer 10 in FIG. 1 to FIG. 5 is an example of the high voltage transformer, and is configured by a core 11, a bobbin 12, a secondary winding 13 being wound onto the outer periphery of the bobbin 12, a casing 14 provided so as to cover the outer periphery of the bobbin 12, a primary winding 15 being wound onto the outer periphery of the casing 14 and the like. In addition, though the high voltage transformer is referred to as an example in this embodiment, the present invention is not limited to the high voltage transformer, but can be applied to general transformers widely.

The core 11 is an I type magnetic material core in a form of a rectangular parallelepiped, and is made of a ferrite material for example.

The bobbin 12 is made of a resin. As shown in detail in FIG. 4 to FIG. 7, the bobbin 12 is provided inside with a hollow portion 16 extending through longitudinally for accommodating and placing the core 11, and is formed integrally with a hollow main body 12a of a substantially cylindrical shape formed in a rectangular cross-sectional shape, and terminal blocks 12b, 12c which are provided at the front end and the rear end of the hollow main body 12a, respectively.

On the outer periphery portion of the hollow main body 12a, a low voltage side coil winding portion 17 that is formed by winding a low voltage side coil winding 13a (hereinafter referred to as “low voltage side coil winding 13a”) of the secondary winding 13 which functions as a high voltage winding of the transformer 10, by a predetermined number of turns, and a high voltage side coil winding portion 18 that is formed by winding a high voltage side coil winding 13b (hereinafter referred to as “high voltage side coil winding 13b”) of the secondary winding 13, by a predetermined number of turns, so that the winding starts from the end of the low voltage side coil winding portion 17, are arranged longitudinally in order. Further, on the outer periphery of the hollow main body 12a, a partition between the low voltage side coil winding portion 17 and the high voltage side coil winding portion 18, and a plurality of flange-like partition plate sections 19 which partition each of the inside of the low voltage side coil winding portion 17 and the high voltage side coil winding portion 18 into a plurality of sections, are provided integrally, at a distance from each other longitudinally.

The terminal block portion 12b is formed integrally with the hollow main body 12a in a state so that protrude toward outward forward direction longitudinally from the lower side of the hollow main body 12a in the low voltage side coil winding portion 17. The terminal block portion 12c is formed integrally with the hollow main body 12a in a state so that protrude toward outward forward direction longitudinally from the lower side of the hollow main body 12a in the high voltage side coil winding portion 18. In addition, in molding the bobbin 12, terminals 20a, 20b, 20c are provided to the terminal block portion 12b by insert molding and terminals 20d, 20e, 20f are provided to the terminal block portion 12c by insert molding.

As shown in detail in FIG. 4 to FIG. 7, the casing 14 is a resin molded body with a hollow portion inside and is attached to the bobbin 12 so as to cover the upper surface, the left and the right side surfaces in the horizontal direction and the front and the rear end surfaces in the longitudinal direction of the hollow main body 12a. On the lower surface of the casing 14, an opening 21 is provided for inserting the bobbin 12 into the inside.

Further, the opening 21 is provided with a plurality of retaining protrusions 22 of a claw shape on each of the left and right side surfaces. When the bobbin 12 is inserted to a predetermined position in the casing 14, the bobbin 12 is secured to the lower surface of the partition plate section 19, and is fixedly held and retained in the casing 14 by the retaining protrusions 22.

On the front end portion and the rear end portion of the outer periphery surface of the casing 14 onto which the primary winding 15 is to be wound which functions as the low voltage winding of the transformer 10, a front side partition plate section 23a and a rear side partition plate section 23b are formed, respectively.

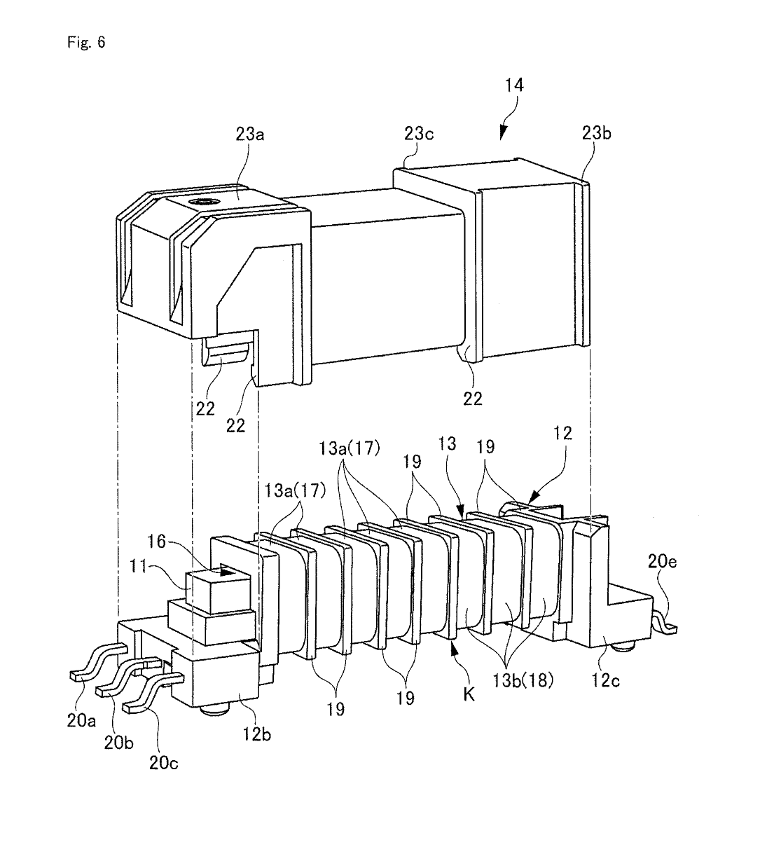

An intermediate partition plate section 23c is provided at a position substantially corresponding to the position of a partition plate section 19 which partitions between the low voltage side coil winding portion 17 and the high voltage side coil winding portion 18 being formed on the outer periphery of the hollow main body 12a in the bobbin 12 (the partition plate section 19 at the location pointed to by the arrow K in FIG. 4 and FIG. 6). The outer periphery surface of the casing 14 between the rear side partition plate section 23b and the intermediate partition plate section 23c is filled.

Then, by winding the primary winding 15 over all the outer periphery region between the front side partition plate section 23a and the intermediate partition plate section 23c, the both end portions of the primary winding 15 are fitted in position with the both end portions of the low voltage side coil winding 13a being wound to the low voltage side coil winding portion 17, and the primary winding 15 is wound in a state being overlapped with the low voltage side coil winding 13a.

Next, an example of the assembling procedure for the transformer 10 configured as above shall be explained. First, the low voltage side coil winding 13a of the secondary winding 13 is wound onto the low voltage side coil winding portion 17 of the bobbin 12, and following the low voltage side coil winding 13a, the high voltage side coil winding 13b of the secondary winding 13 is wound onto the high voltage side coil winding portion 18. In addition, at this time, the coil end of the low voltage side coil winding 13a is bound to the terminal 20c, and the coil end of the high voltage side coil winding 13b is bound to the terminal 20d. Further, if necessary, each of the coil ends and the terminals 20c, 20d are fixed by using a solder or the like.

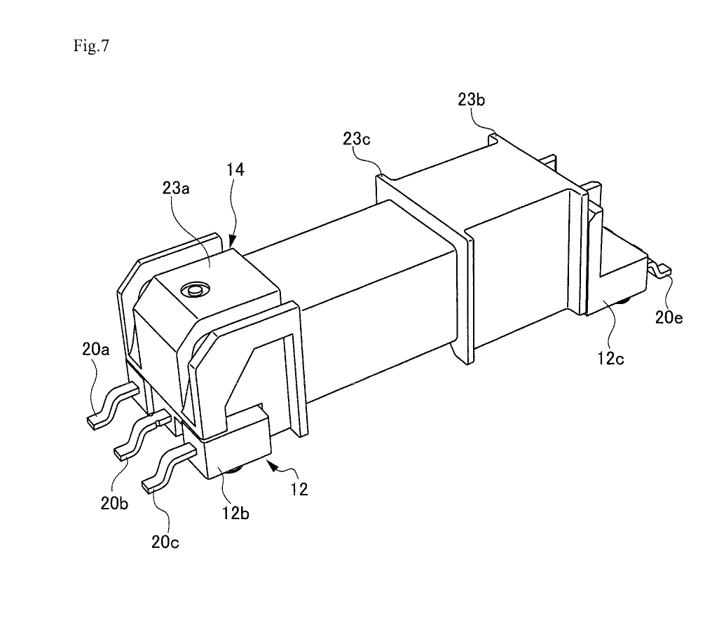

Then, as shown in FIG. 6, the case 14 is covered over the bobbin 12 from the upper side onto which the low voltage side coil winding 13a and the high voltage side coil winding 13b are wound, and the hollow main body 12a of the bobbin 12 is inserted into the inside of the casing 14. When the bobbin 14 is inserted to a predetermined position in the casing 14, the engaging claws 22 of the opening 21 are secured to the lower surface of the partition plate section 19, the case 14 and the bobbin 12 are fixedly held each other and are integrated, in a state where the case 14 covers the upper surface, the left and the right side surfaces, and the front and the rear end surfaces. FIG. 7 illustrates a state immediately after the casing 14 and the bobbin 12 are integrated.

Subsequently, onto the position of the casing 14 on which the primary winding 15 is to be wound, that is the outer periphery portion corresponding to the region between the front side partition plate section 23a and the intermediate partition plate section 23c, an insulation tape 24a is wound by at least one turn, so that the insulation properties between the secondary winding 13 and the primary winding 15 to be wound thereafter are assured.

Then, the primary winding 15 is wound by a predetermined number of turns on the periphery region between the front side partition plate section 23a and the intermediate partition plate section 23c of the casing 14, and the coil ends are bound and connected to each of the terminal 20a and the terminal 20b. Further, if necessary, each of the coil ends and the terminals 20a, 20b are fixed by using a solder or the like. After the completion of the processing of the coil ends of the primary winding 15, an insulation tape 24b is would by at least one turn from the outside of the primary winding 15 so as to cover the outer periphery surface of the primary winding 15, and thereby a short-circuit of the primary winding 15 due to contact with external parts and the like is prevented. In this way, assembling is completed.

Accordingly, with regard to the transformer 10 configured in this way, by covering the bobbin 12 onto which the secondary winding 13 is wound with the casing 14 from the upper side of the bobbin 12 and accommodating the bobbin 12 to a predetermined position in the casing 14 from the side of the opening 21 of the casing 14, the hollow main body 12a is covered with the casing 14, and the engaging claw 22 of the casing 14 engages and retains the bobbin 12, and the bobbin 12 and the casing 14 can be easily fixed together and integrated. Therefore, the work of filling the insulation resin between the casing 14 and bobbin 12 which has been performed in a conventional configuration of the transformer for fixing the bobbin and the casing grows unnecessary.

Further, when accommodating the bobbin 12 in the casing 14, in the case the opening 21 is provided to the lower surface of the casing 14 and the bobbin 12 is covered with the casing 14 from the upper side of the bobbin 12 as disclosed in the configuration of the present example, it is enough to provide an opening 21 having a size of at least the outer diameter of the bobbin 12. As a result, the size of the bobbin 12 can be reduced, downsizing of the transformer 10 becomes possible, and an effect by the higher coupling coefficient can be obtained by getting closer the distance between the primary winding 15 and the secondary winding 13.

Further, it is different from the configuration of the conventional transformer in which the casing and the bobbin are integrated by using through-holes and the like of the printed circuit board side, and so the shape does not depend on the printed circuit board and the like, and a shape configuration having general versatility can be employed.

Further, because the primary winding 15 is wound to the portion overlapping with the low voltage side winding 13a of the secondary winding 13, fitting both ends of the primary winding 15 of to both ends of the low voltage side winding 13a of the secondary winding 13, the parasitic capacitance generated in the high voltage side winding 13a of the secondary winding 13 by the primary winding 15 can be reduced. Thus, the electric power loss at high frequencies can be reduced. In addition, because the energy stored in the parasitic capacitance increases with increasing potential between the primary winding 15 and the secondary winding 13, it grows possible to reduce the energy stored in the parasitic capacitance, and thereby reduce the electric power loss due to the leakage current at high frequencies, by winding the primary winding 15 over the outer periphery of the low voltage side coil winding 13a of the secondary winding 13. Further, the primary winding 15 is wound onto the outer periphery of the casing 14 so as to overlap with the low voltage side coil winding 13a of the secondary winding 13, and so the insulation properties between the primary winding 15 and the secondary winding 13 can be assured.

Further, by winding the primary winding 15 onto the outer periphery of the casing 14, it grows possible to shorten the longitudinal length of the transformer, as compared to a type of the transformer where the primary winding and the secondary winding are wound on a same bobbin. In addition, according to experiments, the coupling coefficient for the type of the transformer where the primary winding and the secondary winding are wound on the same bobbin is about 0.55, whereas the coupling coefficient for the configuration of the present example where the primary winding 15 is wound onto the outer periphery of the casing 14 is about 0.9. Therefore, the coupling coefficient can be improved.

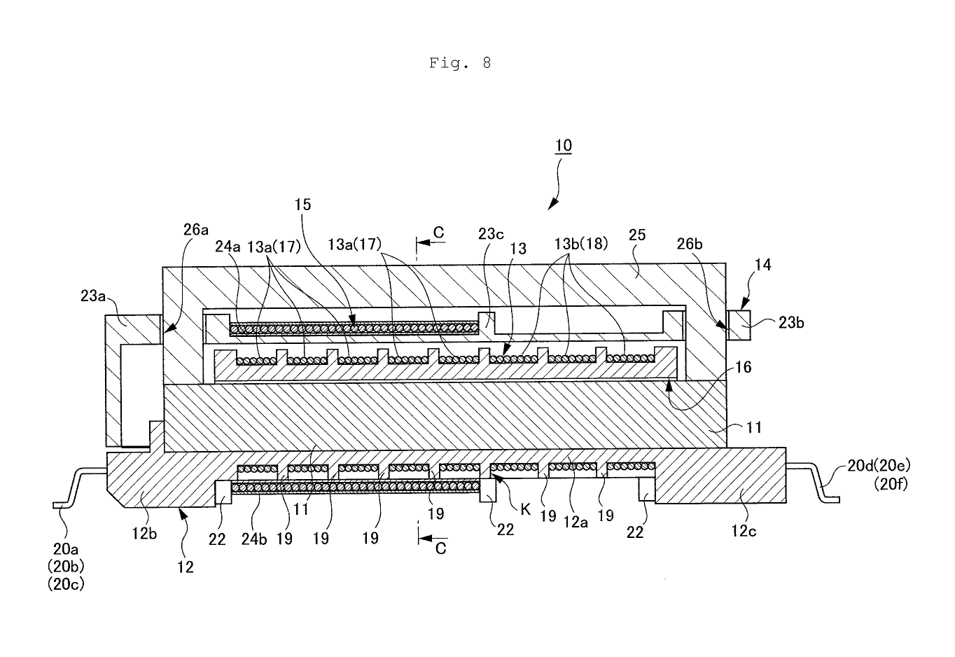

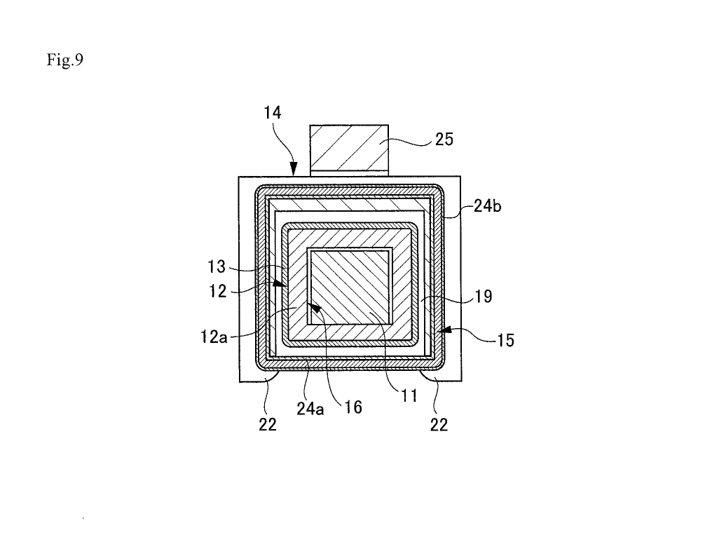

FIG. 8 and FIG. 9 illustrate a transformer according to another embodiment of the present invention. FIG. 8 is a schematic longitudinal sectional view of the transformer. FIG. 9 is a line C-C schematic longitudinal sectional view of FIG. 8.

The transformer 10 shown in FIG. 8 and FIG. 9 has a configuration where the core is composed of the I type magnetic material core 11 and a C type magnetic material core 25. The other configurations are the same as those of the transformer 10 as shown in FIG. 1 to FIG. 7. Therefore, the same reference numerals are given to the same components, and the duplicated description is omitted.

In FIG. 8 and FIG. 9, the inside width between both the end portions of the C type magnetic material core 25 is approximately equals to the distance between the outer surfaces in the longitudinal direction of the hollow main body 12a of the bobbin 12. In addition, the C type magnetic material core 25 is disposed on the upper surface outside of the casing 14, both the end portions thereof are inserted to the inside from each of through-holes 26a, 26b of the casing 14, and are disposed in a state where the end portions are opposed and approximated to each of the I type magnetic material core 11, and then the C type magnetic material core 25 and the I type magnetic material core 11 are configured to form a closed magnetic circuit.

In this way, in the transformer 10 in which the I type magnetic material core 11 and the C type magnetic material core 25 form the closed magnetic circuit, the leakage magnetic flux can be reduced further.

Further, though the transformer has been described as another embodiment which uses both the C type magnetic material core 25 and the I type magnetic material core 11, the transformer can be configured by using only two pieces of the C type magnetic material cores, without using the I type magnetic material core 11. Further, the C type magnetic material core can be configured not on the upper surface outside of the casing, but on the side surface outside of the casing.

Meanwhile, in the present embodiments, it has been described that the primary winding functions as a low voltage winding, and the secondary winding functions as a high voltage winding, but the input voltage can be applied to either the primary winding or the secondary winding, and the output voltage comes from the secondary winding or the primary winding respectively in that case.

As above, the present invention has been described with reference to the embodiments, but it is needless to say that the technical scope of the present invention is not limited to the scope described in the above embodiments. It is apparent to those skilled in the art that a variety of modifications or improvements other than the above can be made.

### INDUSTRIAL APPLICABILITY

In the above described embodiments, the description has been made on the case where the present invention is applied to the high voltage transformer, but the present invention can be applied to a part having a winding other than the high voltage transformer.

### REFERENCE SIGNS LIST

10 . . . transformer, 11 . . . core (I type magnetic material core), 12 . . . bobbin, 12a . . . hollow main body, 12b . . . terminal block portion, 12c . . . terminal block portion, 13 . . . secondary winding, 13a . . . low voltage side coil winding, 13b . . . high voltage side coil winding, 14 . . . casing, 15 . . . primary winding, 16 . . . hollow portion, 17 . . . low voltage side coil winding portion, 18 . . . high voltage side coil winding portion, 19 . . . partition plate section, 20a to 20f . . . terminals, 21 . . . opening, 22 . . . retaining protrusion (engaging claw), 23a . . . front side partition plate section, 23b . . . rear side partition plate section, 23c . . . intermediate partition plate section, 24a . . . insulation tape, 24b . . . insulation tape, 25 . . . core (C type magnetic material core), 26a and 26b . . . through-holes

1-5. (canceled)

6. A transformer comprising:
a core;
a primary winding;
a secondary winding;
a bobbin provided with a low voltage side coil winding portion and a high voltage side coil winding portion, wherein the secondary winding is wound onto each of the coil winding portions; and
a casing disposed so as to cover an outer periphery of the bobbin, wherein the primary winding is wound onto a portion of an outer periphery of the casing corresponding to a position of the low voltage side coil winding portion.

7. The transformer according to claim 6, wherein the secondary winding is a high voltage winding and the primary winding is a low voltage winding, and the primary winding is placed and wound in a portion corresponding to an area between the both ends of the low voltage side coil winding portion.

8. The transformer according to claim 6, wherein the casing is formed in a hollow box-shaped body provided with an opening on a lower surface of the outer periphery thereof for receiving and accommodating the bobbin therein, and the opening has a retaining protrusion to engage the accommodated bobbin.

9. The transformer according to claim 7, wherein the casing is formed in a hollow box-shaped body provided with an opening on a lower surface of the outer periphery thereof for receiving and accommodating the bobbin therein, and the opening has a retaining protrusion to engage the accommodated bobbin.

10. The transformer according to claim 6, wherein the casing is provided with an insulation tape onto the outer periphery thereof where the primary winding is wound.

11. The transformer according to claim 7, wherein the casing is provided with an insulation tape onto the outer periphery thereof where the primary winding is wound.

12. The transformer according to claim 8, wherein the casing is provided with an insulation tape onto the outer periphery thereof where the primary winding is wound.

13. The transformer according to claim 9, wherein the casing is provided with an insulation tape onto the outer periphery thereof where the primary winding is wound.

14. The transformer according to claim 6, wherein the core comprises an I type magnetic body core and a C type magnetic body core.

15. The transformer according to claim 7, wherein the core comprises an I type magnetic body core and a C type magnetic body core.

16. The transformer according to claim 8, wherein the core comprises an I type magnetic body core and a C type magnetic body core.

17. The transformer according to claim 9, wherein the core comprises an I type magnetic body core and a C type magnetic body core.

18. The transformer according to claim 10, wherein the core comprises an I type magnetic body core and a C type magnetic body core.

19. The transformer according to claim 11, wherein the core comprises an I type magnetic body core and a C type magnetic body core.

20. The transformer according to claim 12, wherein the core comprises an I type magnetic body core and a C type magnetic body core.

21. The transformer according to claim 13, wherein the core comprises an I type magnetic body core and a C type magnetic body core.
